(19) United States
(12) Patent Application Publication
(10) Pub. No.: US 2022/0339970 A1
(43) Pub. Date: Oct. 27, 2022

(54) PNEUMATIC TIRE

(71) Applicant: Toyo Tire Corporation, Itami-shi (JP)

(72) Inventor: Yoshiki Sato, Itami-shi (JP)

(73) Assignee: Toyo Tire Corporation, Itami-shi (JP)

(21) Appl. No.: 17/713,326

(22) Filed: Apr. 5, 2022

(30) Foreign Application Priority Data
Apr. 21, 2021 (JP) 2021-071996

(51) Int. Cl. B60C 13/00

(52) U.S. Cl. CPC B60C 13/001

(57) ABSTRACT

A pneumatic tire has a sidewall that extends in a tire radial direction. The the sidewall has an insignia which protrudes toward an exterior in a tire axial direction. The insignia has a strip-like body, an endless-loop-like outline which encompasses the body, and a bridge which is arranged toward an exterior from the endless loop of the outline and which causes a mutually separated pair of the outlines to be mutually connected. Heights by which the body and the outline protrude relative to a reference surface which is an exterior surface in a region peripheral to the insignia are mutually different. A height by which the bridge protrudes relative to the reference surface is less than each of the protruding heights of the body and the outline.

### CROSS REFERENCE TO RELATED APPLICATIONS

This application claims the benefit of priority of Japanese application no. 2021-71996, filed on Apr. 21. 2021, which is incorporated herein by reference.

### BACKGROUND OF THE INVENTION

The present disclosure relates to a pneumatic tire.

An insignia that displays the product name, brand name, andor the like might be provided at the sidewall of a pneumatic tire (see, for example, Japanese Patent Application Publication Kokai No. 2010-64656). The insignia is a projection that protrudes toward the exterior in the tire axial direction from the profile surface (hereinafter also referred to as “reference surface”) which is present in the region peripheral thereto. Increasing the amount by which the insignia protrudes from the profile surface will make it possible to improve the visibility of the insignia. However, this will increase the tendency for cracking to occur at the insignia.

### SUMMARY OF THE INVENTION

The present disclosure provides a pneumatic tire permitting in probed sidewall insignia visibility and resistance to cracking.

According of the present disclosure, there is provided a pneumatic tire having sidewall that extends in a tire radial direction, wherein the sidewall has an insignia which protrudes toward an exterior in a tire axial direction; the insignia has a strip-like body, an endless-loop-like outline which encompasses the body, and a bridge which is arranged toward an exterior from the endless loop of the outline and which causes a mutually separated pair of the outlines to be mutually connected; heights by which the body and the outline protrude relative to a reference surface which is an exterior surface in a region peripheral to the insignia are mutually different; and a height by which the bridge protrudes relative to the reference surface is less than each of the protruding heights of the body and the outline.

### BRIEF DESCRIPTION OF THE DRAWINGS

FIG. 1 Side view of a portion of a sidewall at a pneumatic tire in a first embodiment in accordance with the present disclosure as seen along a line of sight parallel to the tire axial direction.

FIG. 2 Sectional view of section A2-A2 in FIG. 1.

FIG. 3 Sectional views of region A30, region A31, region A32, and region A33 in FIG. 1.

FIG. 4 Sectional views of region A30, region A31, region A32, and region A33 in accordance with a first variation on the first embodiment.

FIG. 5 Side view of an insignia in accordance with a second variation on the first embodiment as seen along a line of sight parallel to the tire axial direction, and sectional views of region A51 and region A52 in the side view.

### DETAILED DESCRIPTION OF THE PREFERRED EMBODIMENTS

### First Embodiment

Below, a first embodiment in accordance with the present disclosure is described with reference to the drawings.

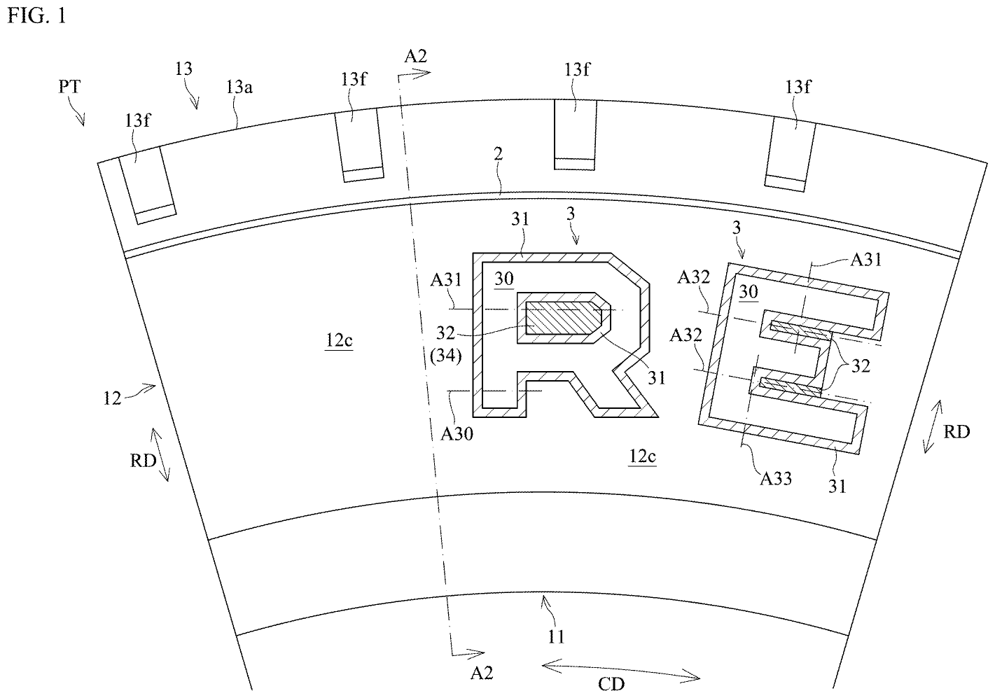

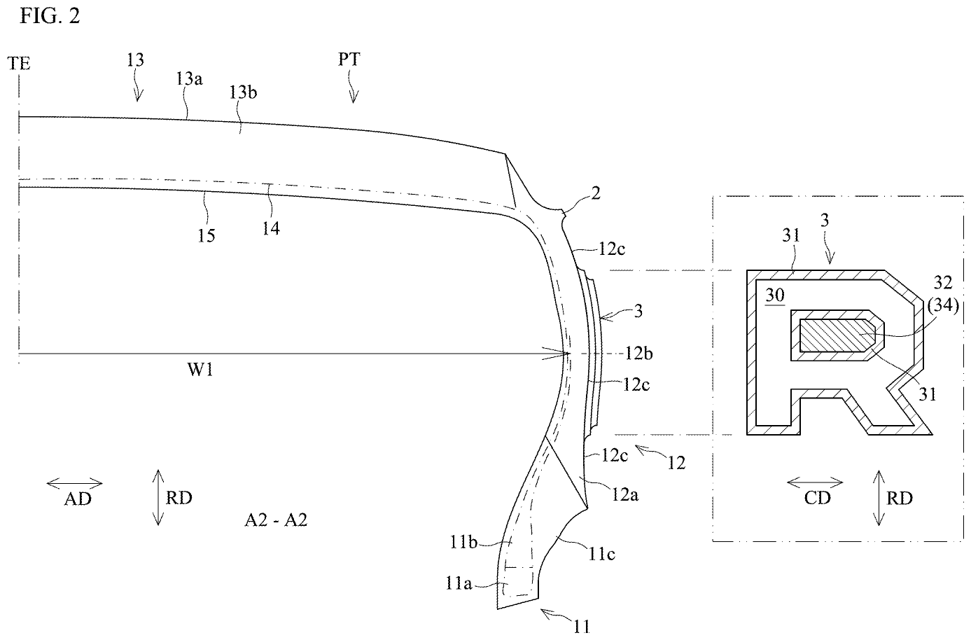

FIG. 1 is a side view of a portion of a sidewall at pneumatic tire PT (hereinafter also referred to as simply “tire PT”) in a first embodiment as seen along a line of sight parallel to the tire axial direction. FIG. 2 is a sectional view (tire meridional section) of section A2-A2 in FIG. 1. FIG. 2 shows only the region to one side in the tire axial direction AD from tire equatorial plane TE.

### Basic Constitution

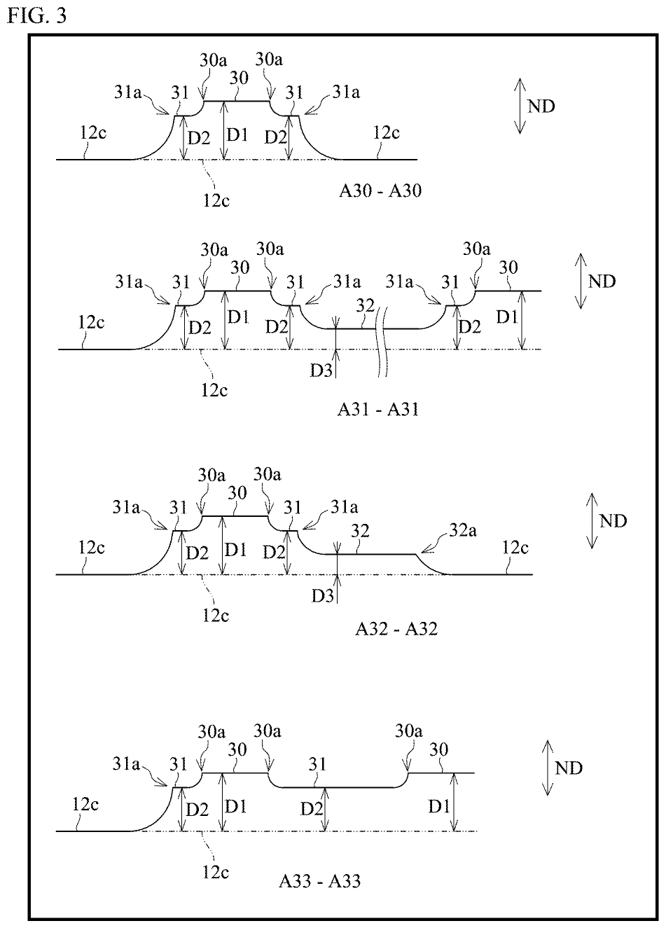

As shown in FIGS. 1 and 3, pneumatic tire PT has a pair of bead regions 11; sidewalls 12 which extend outwardly in the tire radial direction RD from the respective bead regions 11; and tread 13 which is connected to the respective outer ends in the tire radial direction RD of the pair of sidewalls 12 and which has tread surface 13a that comes in contact with the ground surface toward the exterior in the tire radial direction RD.

Tire equatorial plane TE refers to a plane that is located centrally in the tire axial direction AD and that is perpendicular to the rotational axis of the tire. Tire meridional planes refer to planes that are perpendicular to tire equatorial plane TE and that contain the rotational axis of the tire. In the tire axial direction AD, toward the interior means nearer to tire equatorial plane TE, and toward the exterior means farther away from tire equatorial plane TE. Furthermore, in the tire radial direction RD, toward the interior means nearer to the tire rotational axis, and toward the exterior means farther away from the tire rotational axis.

Bead region 11 has bead cote 11a which is formed so as to be annular in shape, and bead filler 11b which is arranged toward the exterior in the tire radial direction RD from bead core 11a. Bead core 11a might, for example, be formed by laminating rubber-covered bead wire(s) (e.g. metal wire(s)). Bead filler 11b comprises hard rubber of higher rubber hardness than that of other rubber member(s) adjacent to bead filler 11b, and is formed such that the cross-sectional shape thereof tapers as one proceeds toward the exterior in the tire radial direction RD.

Furthermore, tire PT has carcass 14 suspended between pair of bead cores 11a, and innerliner 15 that is arranged toward the interior in the tire radial direction RD from carcass 14 and that faces the interior space of tire PT which is or will be filled with air. Carcass 14 and innerliner 15 are arranged in parallel fashion with respect to the inside circumferential surface of the tire over a portion thereof that encompasses bead regions 11, sidewalls 12, and tread 13.

Bead region 11 has rim strip rubber 11c arranged toward the exterior in the tire axial direction AD from carcass 14. Rim strip rubber 11c forms the outer surface that will come in contact with the rim. Sidewall 12 has sidewall rubber 12a arranged toward the exterior in the tire axial direction AD from carcass 14. Sidewall rubber 12a forms the outer surface.

Tread 13 has tread rubber 13b which forms tread surface 13a, and a belt (not shown) which is arranged between tread rubber 13b and carcass 14. The belt has a plurality (e.g., four) belt plies (not shown). The belt plies (not shown) have a plurality of belt cords (e.g., organic fiber and/or metal) which are arrayed in parallel fashion, and topping rubber with which the belt cords are covered.

Carcass 14 is made up of at least one carcass ply (not shown). The carcass ply (not shown) folds back upon itself and wraps about bead core 11a so as to envelop bead core 11a. Furthermore, the carcass ply (not shown) has a plurality of ply cords (e.g., organic fiber and/or metal) which are arrayed in direction(s) more or less perpendicular to the tire circumferential direction CD, and topping rubber with which the ply cords are covered. Note that while carcass 14 is shown in abbreviated fashion as a single-dash chain line in FIG. 2, in actuality it has some nonzero thickness.

Innerliner 15 has superior functionality in terms of its ability to impede passage of gas therethrough so as to permit air pressure to be maintained. Moreover, the constitution at sidewall 12 may be such that, as is the case in the first embodiment, there is no other member that intervenes between innediner 15 and carcass 14.

Sidewalls 12 have locations 12b at the outer surfaces thereof which are at the same locations in the tire radial direction RD as the locations at which tire width is a maximum (more specifically, the locations at which distance W1 between respective exterior points in the tire axial direction AD of carcass 14 is a maximum). Below, these locations 12b are referred to as tire maximum width locations 12b.

While not shown in the drawings, tread rubber 13b has a plurality of main grooves (not shown) extending continuously in the tire circumferential direction CD along the entire length in the tire circumferential direction CD of tread surface 13a, and a plurality of ancillary grooves 13f, each of which extends to one of the outer ends in the tire axial direction AD.

### Sidewall Structure

As shown in FIGS. 1 and 2, sidewall 12 has reference surface 12c, insignia 3 which protrudes toward the exterior in the tire axial direction AD from reference surface 12c, and a plurality of side blocks 4. Insignia 3 may be located at tire maximum width location 12b. Reference surface 12c is the outer surface that is present in the region peripheral to insignia 3. Reference surface 12c is present at least toward the interior in the tire radial direction RD from insignia 3, and is present to either side in the tire circumferential direction CD of insignia 3. In accordance with the first embodiment, reference surface 12c is present toward the interior and toward the exterior in the tire radial direction RD from insignia 3. Reference surface 12c is what is referred to as a “profile surface,” inasmuch as it is arranged at locations that are rotationally symmetric about the tire rotational axis. Reference surface 12c is such that at least a portion thereof extends continuously along the full circumference in the tire circumferential direction CD. As viewed in a tire meridional section, reference surface 12c may be made up of a plurality of arcs of differing radii of curvature. Note that what is referred to as a protruding height in the present specification is the height of protrusion in a direction ND normal to reference surface 12c.

As shown in FIG. 1, as seen along a line of sight parallel to the tire axial direction AD, insignia 3 displays a plurality of characters, shapes, or symbols, or a combination thereof. Letters and numbers may he cited as examples of characters. Insignia 3 has strip-like body 30, endless-loop-like outline 31 which encompasses body 30, and bridge 32. At FIGS. 1, 2, and 5, outline 31 and bridge 32 are indicated by hatching.

Strip-like body 30 displays lines of characters, lines of shapes, and/or lines of symbols. For example, as shown in FIG. 1, the character “R” is made up of two vertical lines, two horizontal lines, and one diagonal line. The character “E” is made up of one vertical line, and three horizontal lines. There are situations in which body 30 has strip-like line(s) that form a closed space 34 as is the case with the letters “A”, “B”, “D”, “O”, “P”, and “Q”; and there are situations in which body 30 has at least two strips that are mutually separated as is the case with the lower portion of “R” or the three lines which are parallel to the tire circumferential direction CD in “E” or the two lines which are parallel to the tire radial direction RD in “U”.

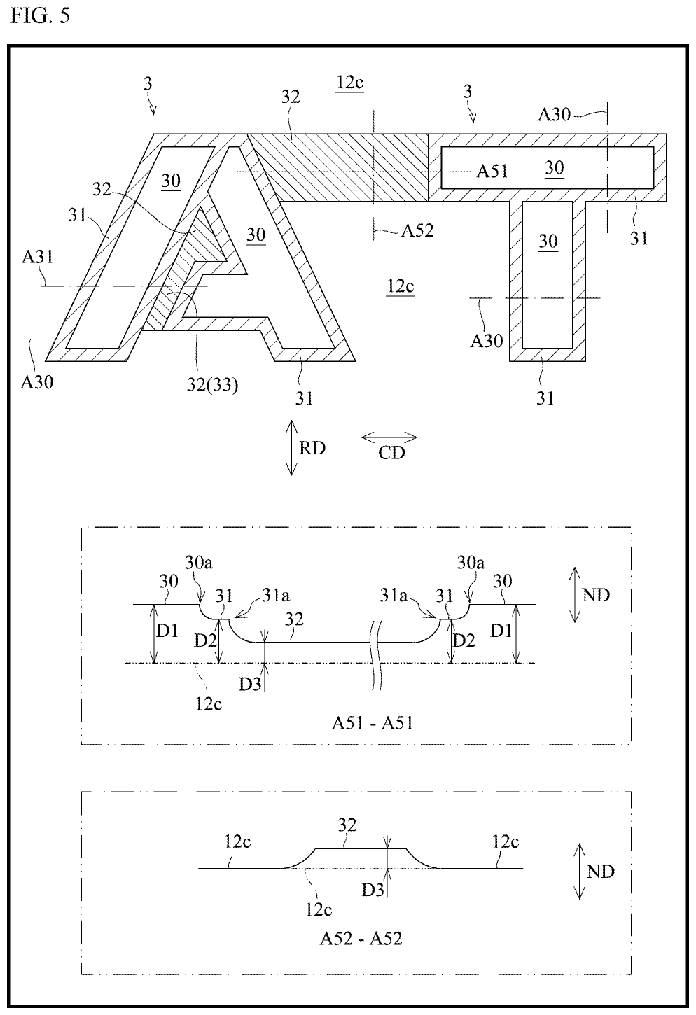

Outline 31 is formed so as to appear as an endless loop as seen along a line of sight parallel to the tire axial direction AD. Outline 31 encompasses body 30 from either side thereof in the tire circumferential direction CD, and also from either side thereof in the tire radial direction RD. There is at least one outline 31 provided at each strip-like body 30. As is the case with the “E” shown in FIG. 1, a single outline 31 may be provided at a strip-like body 30 that does not form a closed space. On the other hand, as is the case with the “R” shown in FIG. 1, at least two outlines 31 may be provided at a strip-like body 30 that forms a closed space 34. The number of outlines 31 may vary in correspondence to the number of closed spaces 34. For example, where there is one closed space 34, there might be two outlines 31; where there are two closed spaces 34, there might be three outlines 31. Furthermore, one or more outlines 31 may be provided at a body 30 even where there is no closed space 34 (see the character “T” in FIG. 5).

Bridge 32 is arranged toward the exterior from the endless loop(s) of outline(s) 31, and causes mutually separated outlines 31 to be mutually connected. “Toward the exterior from the endless loop” means in a direction that would increase distance to body 30 which is surrounded by endless-loop-like outline 31. Body 30 is toward the interior from the endless loop of outline 31. Where a strip-like body 30 forms closed space(s) 34, said closed space(s) 34 will be toward the exterior from the endless loop of outline 31.

Insignia 3 has at least one separating region which is toward the exterior from the endless loop of outline 31. For example, a separating region might be arranged between two sides of outline 31 which extend in the tire radial direction RD, or might be arranged between two sides of outline 31 which extend in the tire circumferential direction CD, or might be arranged in a closed space 34 encompassed by outline 31, or might be arranged between a first character and a second character which are linearly arrayed in the tire circumferential direction CD.

At the example of FIG. 1, insignia 3 displays the character “R”, the character “R” being such that the lines of the character form a closed space. Bridge 32 is formed in the entire region of this closed space 34. Of course, bridge 32 might be formed in at least a portion of closed space 34.

Furthermore, at the example of FIG. 1, insignia 3 displays the character “E”, the character “E” having at least three sides which are separated. These three sides extend in the tire circumferential direction CD, separating regions being formed between the respective sides, there being a total of two strip-like separating regions. Bridges 32 are respectively provided at these two separating regions.

FIG. 3 contains sectional views of region A30, region A31, region A32, and region A33 in FIG. 1. These sectional views show planes parallel to directions ND normal to reference surface 12c. “Toward the exterior in normal direction ND” means in a direction that would increase distance from reference surface 12c in the direction ND of a line drawn normal thereto. Furthermore, “outer end” means the end in a direction that would increase distance from body 30 which is toward the interior from the endless loop.

As shown in FIG. 3, first edge 30a which is the outer end of body 30 protrudes toward the exterior in normal direction ND. First edge 30a is present at the boundary between body 30 and outline 31. Body 30 is a region between first edges 30a. Whereas in the first embodiment shown in FIG. 3 body 30 is only a region of constant protruding height (hereinafter sometimes referred to as “constant protruding height region”) in the section in which body 30, outline 31, and bridge 32 appear, there is no limitation with respect thereto. Serrations may be formed at body 30. The section in which body 30, outline 31, and bridge 32 appear is a section which intersects the direction in which endless-loop-like outline 31 extends.

As shown in FIG. 3, second edge 31a which is the outer end of outline 31 protrudes toward the exterior in normal direction ND. Second edge 31a is present at the boundary between outline 31 and reference surface 12c. Furthermore, second edge 31a is present at the boundary between outline 31 and bridge 32. Outline 31 is a region between first edge 30a and second edge 31a. Whereas in the first embodiment shown in FIG. 3 outline 31 is made up of a constant protruding height region and at least one arc connecting the constant protruding height region and first edge 30a, there is no limitation with respect thereto. For example, outline 31 might be made up of only at least one arc connecting first edge 30a and second edge 31a, there being no constant protruding height region present thereat. Such arc(s)are provided so as to suppress occurrence of cracking. Furthermore, so long as it does not result in formation of an inflection point, outline 31 may contain straight line(s). Because it causes the width of outline 31 to become relatively large, presence of a constant protruding height region at outline 31 permits improvement in visibility.

It may be the case that a connecting portion which connects reference surface 12c and second edge 31a of outline 31 has at least one arc, reference surface 12c and second edge 31a of outline 31 being connected without presence of an inflection point.

As shown in FIG. 3, third edge 32a which is the outer end of bridge 32 protrudes toward the exterior in normal direction ND. Third edge 32a is present at the boundary between bridge 32 and reference surface 12c. Bridge 32 is a region between second edges 31a (see region A31), or a region between second edge 31a and third edge 32a (see region A32). Whereas in the first embodiment shown in FIG. 3 bridge 32 is made up of a constant protruding height region and at least one arc connecting the constant protruding height region and second edge 31a, there is no limitation with respect thereto. Bridge 32 might be made up of at least one arc, there being no constant protruding height region present thereat.

As mentioned above, it is absolutely necessary that there be a curved surface between bridge 32 and outline 31. It is absolutely necessary that there be a curved surface between outline 31 and body 30. This is because if there were no curved surface therebetween, this would cause an inflection point to he formed, which would lead to occurrence of cracking. Radius of curvature of the curved surface between bridge 32 and outline 31 might be not less than 0.2 mm but not greater than 2.0 mm. The significance of this is so as to be on the same order as or less than the difference in protruding heights of outline 31 and bridge 32, described below. Radius of curvature between body 30 and outline 31 might be not less than 0.2 mm but not greater than 1.0 mm. The significance of this is so as to be on the same order as or less than the difference in protruding heights of outline 31 and body 30, described below.

As shown in FIG. 3, height D1 by which the constant protruding height region at body 30 protrudes relative to reference surface 12c (e.g., minimum protruding height D1 of body 30) and height D2 by which the constant protruding height region at outline 31 protrudes relative to reference surface 12c (e.g., minimum protruding height D2 of outline 31) are mutually different. At the example shown in FIG. 3. height D1 by which the constant protruding height region at body 30 protrudes relative to reference surface 12c is greater than height D2 by which the constant protruding height region at outline 31 protrudes relative to reference surface 12c. This permits improvement in the visibility of insignia 3.

Here, because outline 31 has both a constant protruding height region and an arc, the protruding height of outline 31 might be taken to be the minimum protruding height at outline 31.

As shown in FIG. 3, height D3 by which the constant protruding height region at bridge 32 protrudes from the reference surface (e.g., minimum protruding height D3 of bridge 32) is less than each of protruding heights D1 and D2 of the constant protruding height regions at body 30 and outline 31 (e.g., minimum protruding height D1 of body 30 and minimum protruding height D2 of outline 31).

Here, because bridge 32 has both a constant protruding height region and an arc, the protruding height of bridge 32 might be taken to be the minimum protruding height at bridge 32.

It is preferred that the difference between the protruding heights of body 30 and outline 31 be not less than 0.2 mm but not greater than 1.0 mm. Where this difference is less than 0.2 mm, visibility will be poor. Furthermore, if this difference exceeds 1.0 mm, this will tend to cause entrapment of air and lead to introduction of air during vulcanization of the tire.

It is preferred that the difference between the protruding heights of outline 31 and bridge 32 be not less than 0.2 mm but not greater than 2.0 mm. Where this difference is less than 0.2 mm, visibility will be poor. Furthermore, if this difference exceeds 2.0 mm, this will tend to cause occurrence of cracking.

If bridge 32 protrudes more than outline 31, this will improve resistance to cracking but will have the negative consequence of increased tendency for occurrence of bare spots and/or worsening of visibility.

If the protruding heights of body 30 and bridge 32 are the same, visibility will be poor. The protruding heights of body 30 and bridge 32 are therefore made different.

Sidewall 12 may, as is the case in the first embodiment, have annular projection 2 that extends in the tire circumferential direction CD and that protrudes in the tire axial direction AD. Annular projection 2 is arranged toward the exterior in the tire radial direction RD from insignia 3. Annular projection 2 and insignia 3 are mutually separated. Annular projection 2 may, as is the case in the first embodiment, extend continuously in the tire circumferential direction CD along the entire length in the tire circumferential direction CD of sidewall 12.

Furthermore, sidewall 12 may have a plurality of side blocks (not shown) toward the exterior in the tire radial direction RD from insignia 3. The plurality of side blocks may be arranged at spaced intervals in the tire circumferential direction CD such that grooves are straddled therebetween. The plurality of side blocks may be arranged only toward the exterior in the tire radial direction RD from annular projection 2, or may be arranged only toward the interior in the tire radial direction RD from annular projection 2, or may be arranged toward both the interior and the exterior in the tire radial direction RD from annular projection 2. The side blocks and insignia 3 are mutually separated.

Note that the foregoing respective dimensions, positional relationships, and relative magnitudes should be understood to be as measured under normal conditions when tire PT mounted on a normal rim and inflated to normal internal pressure is under no load. A normal rim is that particular rim which is specified for use with a particular tire in the context of the body of standards that contains the standard that applies to the tire in question. This is referred to as a “standard rim” in the case of JATMA, and as a “measuring rim” in the case of TRA or ETRTO.

Normal internal pressure is that air pressure which is specified for use with a particular tire in the context of the body of standards that contains the standard that applies to the tire in question. This is referred to as “maximum air pressure” in the case of JATMA, the maximum value listed in the table entitled “Tire Load Limits at Various Cold Inflation Pressures” in the case of TRA, and as “inflation. pressure” in the case of ETRTO.

### Variations

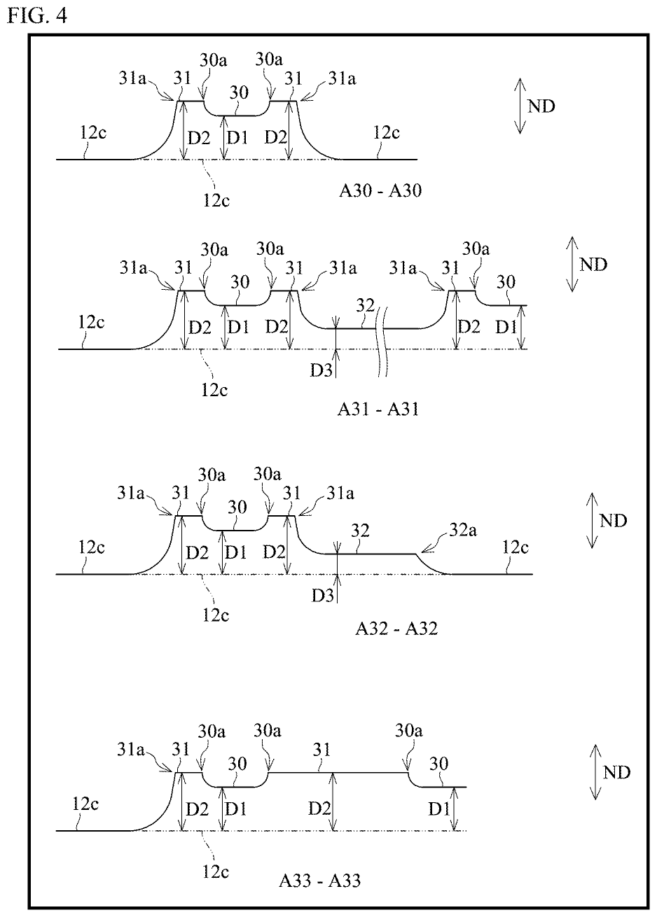

(1) FIG. 4 contains sectional views of region A30, region A31, region A32, and region A33 in accordance with a first variation. The protruding heights of body 30 and outline 31 at FIG. 3 may be changed so as to be the protruding heights of body 30 and outline 31 at FIG. 4. That is, at the first embodiment shown in FIG. 3, protruding height D1 of body 30> protruding height D2 of outline 31> protruding height D3 of bridge 32. In contradistinction thereto, as shown in FIG. 4, protruding, height D2 of outline 31> protruding height D1 of body 30> protruding height D3 of bridge 32.

In such case, it is preferred that the difference between the protruding heights of body 30 and outline 31 be not less than 0.2 mm but not greater than 1.0 mm. Where this difference is less than 0.2 mm, visibility will be poor. Furthermore, if this difference exceeds 1.0 mm, this will tend to cause entrapment of air and lead to introduction of air during vulcanization of the tire.

Furthermore, assuming that body 30 and bridge 32 should not have the same protruding height, it is preferred that the difference between the protruding heights of outline 31 and bridge 32 be not less than 0.4 mm but not greater than 3.0 mm. Where this difference is less than 0.4 mm, visibility will be poor. Furthermore, if this difference exceeds 3.0 mm, this will tend to cause occurrence of cracking.

(2) The constitution indicated at (1) is more likely to cause occurrence of entrapment of air at body 30 than is the case at the first embodiment shown in FIG. 3. To address this, it is preferred that serrations which collectively follow outline 31 be formed at body 30. The protruding height of the serrations might be less than the difference between the protruding heights of body 30 and outline 31. Alternatively, the protruding height of the senations might be not greater than 90% but not less than 50% of the difference between body 30 and outline 31. If the protruding height of the serrations is too large, this will cause visibility to worsen; if it is too small, it will be unlikely that the serrations will be able to provide air-releasing benefit.

(3) FIG. 5 is a side view of an insignia in accordance with a second variation as seen along a line of sight parallel to the tire axial direction, and sectional views of region A51 and region A52. The sectional views of region A30 and region A31 in FIG. 5 are the same as the sectional views of region A30 and region A31 in FIG. 3. As shown in FIG. 5, insignia 3 displays a first character which is the letter “A”, and a second character which is the letter “T”. The first character “A” has two bodies 30, and two endless-loop-like outlines 31 which respectively encompass the two bodies 30. The lines making up the character “A” are divided into two groups such that two bodies 30 are displayed. The character “A” is made up of two diagonal lines and one horizontal line. The horizontal line is divided by strip-like dividing portion 33. Bridge 32 is provided along the entire length in the tire radial direction RD of dividing portion 33. Of course, bridge 32 might be provided at at least a portion of dividing portion 33.

Furthermore, as shown in FIG. 5, the second character “T” has two bodies 30, and two endless-loop-like outlines 31 which respectively encompass the two bodies 30. The lines making up the character “T” are divided into two groups such that two bodies 30 are displayed. The character “T” is made up of one horizontal line which is parallel to the tire circumferential direction CD, and one vertical line which is parallel to the tire radial direction RD.

First character “A” and second character “T” are linearly arrayed in the tire circumferential direction CD. O. This bridge 32 extends in the same direction as the direction in which the first character and the second character are linearly arrayed (the tire circumferential direction CD). Bridge 32 which connects outline 31 of first character “A” and outline 31 of second character “T” may be such that a dimension in the tire circumferential direction CD of said bridge 32 is greater than a dimension thereof in the tire radial direction RD.

(4) Whereas body 30, outline 31, and bridge 32 are respectively provided with constant protruding height regions, they may be provided with flat surfaces instead of constant protruding height regions.

As described above, as in the first embodiment shown in FIG. 1 through 3 or the variations shown in FIGS. 4 and 5, the pneumatic tire may have a sidewall 12 that extends in a tire radial direction RD, wherein the sidewall 12 may have an insignia 3 which protrudes toward an exterior in a tire axial direction RD; the insignia 3 may have a strip-like body 30, an endless-loop-like outline 31 which encompasses the body 30, and a bridge 32 which is arranged toward an exterior from the endless loop of the outline 31 and which causes a mutually separated pair of the outlines 31 to be mutually connected; heights by which the body 30 and the outline 31 protrude relative to a reference surface 12c which is an exterior surface in a region peripheral to the insignia 3 are mutually different; and a height by which the bridge 32 protrudes relative to the reference surface 12c is less than each of the protruding heights of the body 30 and the outline 31.

As a result of adoption of such constitution, because the height by which body 30 protrudes relative to reference surface 12c which is present in the region peripheral to insignia 3 and the height by which endless-loop-like outline 31 which encompasses body 30 protrudes relative to reference surface 12c will be mutually different, the shadow at body 30 and outline 31 will be definite, permitting improvement in visibility. Furthermore, it is often the case that reference surface 12c is present toward the exterior from the endless loop of outline 31, and there are also many situations in which reference surface 12c is present in the separating region between mutually separated outlines 31. Where there is a large difference in height between outline 31 and reference surface 12c of the separating region, it will tend to be the case that an arc cannot be provided at the connecting portion which connects outline 31 and reference surface 12c of the separating region, and that there will be creation of an inflection point at that connecting portion, resulting in the possibility that this could lead to occurrence of cracking.

By therefore—as is the case in the present disclosure—causing bridge 32 which mutually connects outlines 31 to be provided in the separating region, presence of bridge 32 makes it possible to reduce the difference in height between outline 31 and the separating region, and makes it possible for arc(s) to be appropriately arranged at the connecting portion which connects outline 31 and bridge 32, more than would be the case were the constitution such that there was no bridge 32 in the separating region. As a result, it will be possible to suppress occurrence of cracking.

As in the first embodiment shown in FIG. 1 through 3 or the variations shown in FIGS. 5, the height D1 by which the body 30 protrudes relative to the reference surface 12c may be greater than the height D2 by which the outline 31 protrudes relative to the reference surface 12c.

As a result of adoption of such constitution, the tendency for rubber to contact the surface of the portion of the mold that forms outline 31 will be increased and bare spots and introduction of air will be capable of being suppressed during vulcanization of the tire, more than would be the case were the constitution such that height D1 by which body 30 protrudes relative to reference surface 12c is less than height D2 by which outline 31 protrudes relative to reference surface 12c.

As in the first embodiment shown in FIG. 1 through 3 or the variations shown in FIGS. 5, the body 30 may have a first constant protruding height region at which protruding height D1 relative to the reference surface 12c is constant; the outline 31 may have a second constant protruding height region at which protruding height D2 relative to the reference surface 12c is constant; the bridge 32 may have a third constant protruding height region at which protruding height D3 relative to the reference surface 12c is constant; the protruding height D1 of the first constant protruding height region may be greater than the protruding height D2 of the second constant protruding height region; and the protruding height D3 of the third constant protruding height region may be less than each of the protruding heights D1, D2 of the first constant protruding height region and the second constant protruding height region.

As a result of adoption of such constitution, because it will be possible to cause body 30, outline 31, and bridge 32 to respectively be provided with constant protruding height regions, this will make it possible to ensure that body 30, outline 31, and bridge 32 will respectively be of adequate width, and will make it possible to improve visibility.

As in the variations shown in FIGS. 4, the height D1 by which the body 30 protrudes relative to the reference surface 12c may be less than the height D2 by which the outline 31 protrudes relative to the reference surface 12c, and serrations are formed at the body 30.

As a result of adoption of such constitution, whereas the fact that height D1 by which body 30 protrudes relative to reference surface 12c is less than height D2 by which outline 31 protrudes relative to reference surface 12c might otherwise lead to the problem in which there is a tendency for occurrence of entrapment of air during vulcanization of the tire, because serrations are formed at body 30, this creates a tendency for air to follow the serrations and be released therefrom, as a result of which it is possible to suppress introduction of air thereinto. Note that this is because a vent hole for release of air would be provided at the region of the mold which most protrudes (outline 31 at the example of FIG. 4).

As in the letter “R” in the first embodiment shown in FIG. 1 through 3 or the variations shown in FIGS. 5, the insignia 3 may display a character; the character may be such that a line of the character forms a closed space 34; and the bridge 32 may be provided in at least a portion of the closed space 34.

There is a tendency for regions within closed spaces 34 formed by lines of characters to become narrow. As a result of adoption of such constitution, notwithstanding that character(s) forming such closed space(s) 34 may be provided on sidewall 12, because at least a portion of closed space(s) 34 are provided with bridge(s) 32, it will be possible to appropriately improve resistance to cracking.

As in the letter “A” in the variations shown in FIGS. 5, the insignia 3 may display a character; the insignia 3 may have a strip-like dividing portion 33 that divides a line of the character; and the bridge 32 is provided at at least a portion of the dividing portion 33.

As a result of adoption of such constitution, not only does dividing portion 33 make it possible to improve visual appearance but the cracking that might otherwise have been produced due to presence of dividing portion 33 is able to be suppressed due to presence of bridge(s) 32.

As in the letter “A” and “T” in the variations shown in FIGS. 5, the insignia 3 may display a first character (A) and a second character (T) which may be linearly arrayed in a tire circumferential direction CD; and the bridge 32 may connect the outline 31 of the first character (A) and the outline 31 of the second character (T).

As a result of adoption of such constitution, because the first character and the second character are connected by bridge 32, this makes it possible to improve resistance to cracking.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising a sidewall that extends in a tire radial direction, wherein
the sidewall has an insignia which protrudes toward an exterior in a tire axial direction;
the insignia has a strip-like body, an endless-loop-like outline which encompasses the body, and a bridge which is arranged toward an exterior from the endless loop of the outline and which causes a mutually separated pair of the outlines to be mutually connected;
heights by which the body and the outline protrude relative to a reference surface which is an exterior surface in a region peripheral to the insignia are mutually different; and
a height by which the bridge protrudes relative to the reference surface is less than each of the protruding heights of the body and the outline.

2. The pneumatic tire according to claim 1 wherein the height by which the body protrudes relative to the reference surface is greater than the height by which the outline protrudes relative to the reference surface.

3. The pneumatic tire according to claim 2 wherein
the body hasa first constant protruding height region at which protruding height relative to the reference surface is constant;
the outline has a second constant protruding height region at which protruding height relative to the reference surface is constant;
the bridge has a third constant protruding height region at which protruding height relative to the reference surface is constant;
the protruding height of the first constant protruding height region is greater than the protruding height of the second constant protruding height region; and
the protruding height of the third constant protruding height region is less than each of the protruding heights of the first constant protruding height region and the second constant protruding height region.

4. The pneumatic tire according to claim 1 wherein the height by which the body protrudes relative to the reference surface is less than the height by which the outline protrudes relative to the reference surface, and serrations are formed at the body.

5. The pneumatic tire according to claim 1 wherein the insignia displays a character; the character is such that a line of the character forms a closed space; and the bridge is provided in at least a portion of the closed space.

6. The pneumatic tire according to claim 1 wherein the insignia displays a character; the insignia has a strip-like dividing portion that divides a line of the character; and the bridge is provided at at least a portion of the dividing portion.

7. The pneumatic tire according to claim 1 wherein the insignia, displays a first character and a second character which are linearly arrayed in a tire circumferential direction; and the bridge connects the outline of the first character and the outline of the second character.
